(19) United States
(12) Patent Application Publication
(10) Pub. No.: US 2005/0289208 A1
(43) Pub. Date: Dec. 29, 2005

(54) Methods and apparatus for determining quotients

(76) Inventors: John R. Harrison, Beaverton, OR (US); Ping T. Tang, Castro Valley, CA (US)

Correspondence Address: GROSSMAN & FLIGHT LLC, Suite 4220, 20 North Wacker Drive, Chicago, IL, 60606-6357, US

(21) Appl. No.: 10/874,951

(22) Filed: Jun. 23, 2004

(51) Int. Cl. G06F 7/38

(52) U.S. Cl. 708/502

(57) ABSTRACT

Methods, apparatus, and articles of manufacture for determining quotient values are disclosed. An example method identifies a reciprocal value of a divisor value. A bias value is then identified and a biased quotient value is determined based on a dividend value, the reciprocal value, and at least a portion of the bias value. A quotient value is then determined based on the biased quotient value.

### FIELD OF THE DISCLOSURE

The present disclosure relates generally to processor systems and, more particularly, to methods, apparatus, and articles of manufacture for determining quotient values within processor systems.

### BACKGROUND

It is often desirable to determine quotient values based on integer values that are stored in floating-point registers. Integer-based processor systems often include floating-point registers for use with floating-point instructions. In some instances, integer values are often stored in the floating-point registers that require the use of floating-point instructions. An alternative to using floating-point instructions to operate on integer values stored in floating-point registers involves copying the integer values to an integer register to enable the use of integer-based instructions. However, copying the integer values from one register to another register often consumes a significant number of processing cycles, and in some cases more processing cycles than would be consumed by using floating-point instructions to perform the desired operation in the first instance.

Base conversion is an example application that often involves determining quotient values based on integer values stored in floating-point registers. In general, processor systems (e.g., computers) store values in a base-two or binary format. The binary values are typically converted to other base formats (e.g., octal format (base-eight), decimal format (base-ten), hexadecimal format (base-sixteen), etc.) prior to being displayed on a monitor. In particular, a processor system is most often used to run applications that display values in a base-ten or decimal format using a binary-to-decimal conversion. Frequent use of such binary-to-decimal conversions in a typical processor system imposes significant processing.

A known method for performing a binary-to-decimal conversion repeatedly divides an initial value n (i.e., the value to be converted) by 10 to determine each digit for base-ten format representation. Another known method for performing binary-to-decimal conversion divides the value to be converted by different orders of magnitude. In general, the initial value n may first be divided by 10⁶ followed with a division by 10⁵ followed with divisions by a series of values having successively lower orders of magnitude until a division by 10¹ is reached and all of the base ten digits of the initial value n are determined. Of course, the powers of ten used for the divisions may be any array of powers such as, for example, an array including division by 10⁸, division by 10⁴, division by 10², and division by 10¹.

In general, division operations are relatively complex and require a greater number of processing cycles to implement than more basic operations such as, for example, addition operations and multiplication operations. As noted above, using division to perform binary-to-decimal conversions imposes significant processing requirements on a processor system. A known method that is often used to reduce the number of or eliminate the use of division operations involves performing reciprocal multiplication. In particular, reciprocal multiplication may be used to determine a quotient value using a multiplication operation based on a dividend value and a reciprocal value of a divisor value.

In cases involving integer values stored in integer registers, division by multiplication is often used to determine quotient values. However, implementing division by multiplication based on integer values stored in floating-point registers is typically a cumbersome and inefficient process because known processes require the use of floating-point instructions.

### BRIEF DESCRIPTION OF THE DRAWINGS

FIG. 1 is an example binary representation of a known floating-point data type.

FIG. 2 is a flow diagram of an example method for determining a quotient value and a remainder value using a fused multiply accumulate instruction.

FIG. 3 is a flow diagram of a base conversion application that may be implemented using the fused multiply accumulate instruction and the example methods of FIG. 2.

FIG. 4 is a block diagram of an example system that may be configured to determine a quotient value and a remainder value.

FIG. 5 is a block diagram of another example system that may be configured to determine a quotient value and a remainder value.

FIG. 6 is a block diagram of an example processor system that may be used to implement the apparatus and methods described herein.

### DETAILED DESCRIPTION

Although the following discloses example systems including, among other components, software executed on hardware, it should be noted that such systems are merely illustrative and should not be considered as limiting. For example, it is contemplated that any or all of these hardware and software components could be embodied exclusively in hardware, exclusively in software, or in any combination of hardware and software. Accordingly, while the following describes example systems, persons of ordinary skill in the art will readily appreciate that the examples provided are not the only way to implement such systems.

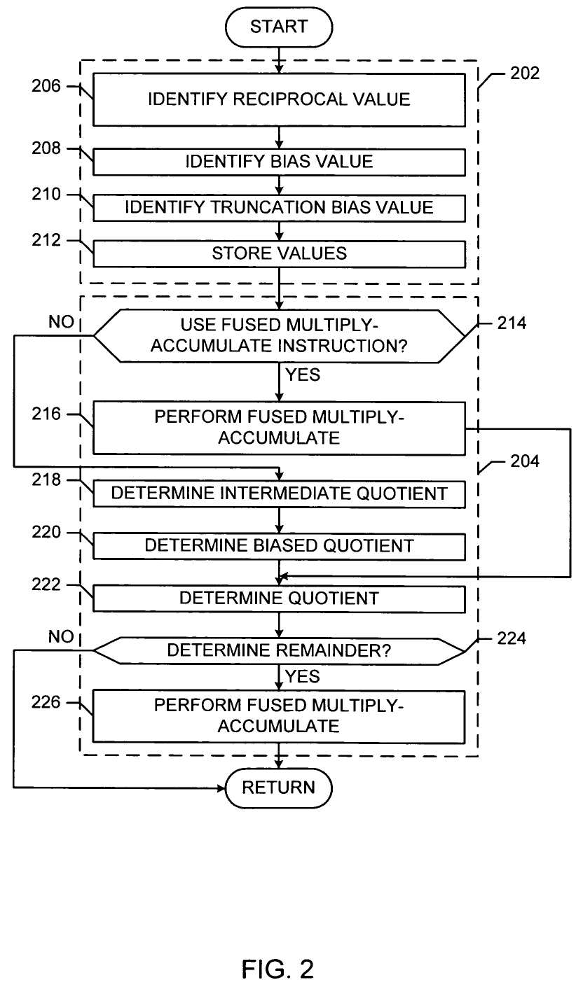

The example methods and apparatus described herein may be used to determine quotient values based on integer values stored in a floating-point data type format (e.g., in a floating-point register). In particular, the example methods and apparatus use multiplication to determine quotient values by identifying a reciprocal value of a divisor value, identifying a bias value, and determining a biased quotient value based on a dividend value, the reciprocal value, and at least a portion of the bias value (i.e., a truncation bias value described below in connection with FIG. 2). The example methods and apparatus may further be used to determine a quotient value based on the biased quotient value. More specifically, the bias value is used to isolate the integer portion of a quotient value in a bitfield comprising a floating-point value. The integer quotient value may then be recovered from the bitfield as described below in greater detail. In addition, a remainder value may also be determined based on the quotient value, the divisor value, and the dividend value.

The example methods and apparatus use multiplication and addition operations to determine quotient and remainder values by biasing one or more intermediate values to achieve results that are more accurate and precise than those provided by known techniques based on use of division operations. Further, multiplication and addition operations are less complex and require fewer processor cycles than division operations. In one example, the methods and apparatus are configured to use a fused multiply accumulate (FMA) instruction (i.e., a floating-point multiply add instruction, a floating-point multiply accumulate instruction, etc.) to determine quotient values. The FMA instruction integrates the operations associated with a multiplication and an addition within one instruction that, when executed, performs only one rounding operation as described below. Additionally, the FMA instruction may be implemented (e.g., may be executed by) general purpose processors such as, for example, the Intel® Itanium® processor. In another example, the methods and apparatus may be configured to use separate (i.e., non-integrated) multiplication and addition instructions or operations to determine quotient values.

Before describing in detail the example methods and apparatus, it is important to understand the physical representation of a floating-point data type. In particular the methods and apparatus described herein may be used in combination with floating-point data types that conform with the IEEE Floating-Point Standard 754-1985. Floating-point values may be used to provide a binary representation of decimal values and are typically represented using various standard formats having corresponding precisions. However, one of ordinary skill in the art will recognize that the floating-point data type may be adapted to suit the particular needs of certain applications. In general, the numeric range of a floating-point data type is based on the IEEE Floating-Point Standard 754-1985.

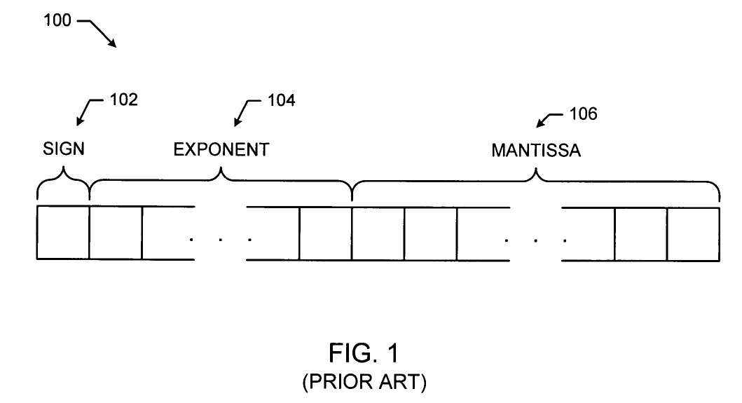

FIG. 1 is an example binary representation 100 of a known floating-point data type. The example binary representation 100 of the floating-point data type shown in FIG. 1 includes a sign bit 102, an exponent bitfield (e) 104, and a mantissa bitfield (f) 106, which is also known as a significand or the fractional portion. Floating-point values are typically represented using various bit lengths corresponding to different precisions such as, for example, single precision, single extended precision, double precision, and double extended precision. For example, as is well known in the art, double precision floating-point values are 64-bit values having fifty-three bits of precision and double extended precision floating-point values are at least seventy-nine bits in length and have at least sixty-four bits of precision. For a double-precision floating-point value, the sign bit 102 is represented by bit sixty-three, the exponent bitfield 104 is eleven bits long and is represented by bits fifty-two through sixty-two, and the mantissa bitfield 106 is fifty-two bits long and is represented by bits zero through fifty-one. For a double extended precision floating-point value, the sign bit 102 is represented by bit seventy-eight, the exponent bitfield 104 is fifteen bits long and is represented by bits sixty-three through seventy-seven, and the mantissa bitfield 106 is sixty-three bits long and is represented by bits zero through sixty-two.

It is well known in the art that the precision of a floating-point data type is related to the mantissa bitfield 106 and a leading implicit bit (i.e., not physically represented). In normalized floating-point values, the leading bit is a binary one (i.e., 1.f), which is separated from the bits in the mantissa bitfield 106 by an implicit radix point or binary point. The leading bit and the binary point are implicit and, thus, are not stored in any of the bit locations of the example binary representation 100 of the floating-point data type of FIG. 1. Floating-point values are typically stored in normalized form, which preserves the precision of the value stored in the mantissa bitfield 106. In this manner, fifty-three bits of precision for a double precision floating-point value can be represented by fifty-two bits in the mantissa bitfield 106 and the implicit bit to the left of the binary point.

The floating-point data type also uses a floating-point bias value (i.e., fp-bias value). The fp-bias value of a double-precision floating-point data type is equal to one thousand twenty-three. Additionally, the fp-bias value is equal to half of the range of the exponent bitfield 104 minus one (e.g.,

$$\frac{{2}^{11}}{2} - 1 = 1023$$

).

A numeric conversion of a floating-point encoded value (e.g., the example binary representation 100) typically involves determining a numeric equivalent value of the floating-point encoded value. A floating-point encoded value (e.g., an integer value) may be, for example, any value that is encoded according to the example binary representation 100 of the floating-point data type. Determining the equivalent numeric value of a floating-point encoded value involves a numeric conversion process based on the sign bit 102, the exponent bitfield 104, the mantissa bitfield 106, and a floating-point exponent value (i.e., fp-exponent value), which is determined based on the fp-bias value and the value stored in the exponent bitfield 104 as described below.

The sign bit 102 specifies the sign of the equivalent numeric value. The exponent bitfield 104 and the mantissa bitfield 106 specify the magnitude and fractional portion of the equivalent numeric value. In particular, the fp-exponent value is determined by subtracting the fp-bias value from the value stored in the exponent bitfield 104 (i.e., e−fpbias). In general, the fp-bias value is selected so that positive and negative exponent values can be generated based on the value stored in the exponent bitfield 104. More specifically, the numeric conversion of a floating-point encoded value may be performed according to Equation 1 below.
V_{FP}=(−1)^{[signbit]}·2^{e-bias}·(1.f) Equation 1
As shown in Equation 1, the numeric equivalent value of a floating-point encoded value is represented by the variable V_{FP}. As depicted in Equation 1 above, V_{FP} is determined by multiplying the value stored in the mantissa bitfield 106 by the value of two raised to a power equal to the fp-exponent value, and then multiplying the result by a negative one raised to a power equal to the value stored in the sign bit 102.

FIG. 2 is a flow diagram of an example method for determining a quotient value and a remainder value using a fused multiply accumulate instruction. In particular, the example method of FIG. 2 may be used to generate quotient values based on a division by multiplication technique using the FMA instruction or separate multiplication and addition instructions.

The FMA instruction, when executed, performs a multiplication operation and an addition operation as one instruction with only one rounding operation. The FMA instruction, which is expressed in the Intel® IA-64 Architecture instruction set as fma.pc.sf f₁=f₃,f₄,f₂ is represented mathematically as set forth in Equation 2 below.
f₁=(f₃×f₄)+f₂ Equation 2
When executed, the FMA instruction first determines the product of the values f₃ and f₄ to infinite precision. As is well known in the art, a binary floating-point value may be represented as having infinite precision by generating a value that represents exactly the result of an operation. In other words, infinite precision implies that the resultant value of an operation is not rounded. The value f₂ is then added to the product, again producing a result of infinite precision. The resulting value of the addition operation is then rounded to a desired precision and stored as the value f₁. In the Intel® IA-64 Architecture, the desired precision is indicated by the parameter pc of the FMA instruction and may be set to single precision or double precision. By not rounding the product of the multiplication operation, the FMA instruction is capable of maintaining a value having infinite precision throughout its execution. In this memory, the method of FIG. 2 may be used to perform division by multiplication to generate quotient values and remainder values that are at least as accurate and precise as those generated using more complex and time consuming division instructions.

In contrast to using the FMA instruction, implementing a multiply accumulate operation using a discrete multiplication instruction and a discrete addition instruction results in two rounding operations. In some cases, using this method to generate quotient and remainder values may result in values that are relatively less accurate and precise than those determined using the above-described FMA instruction. However, using discrete multiplication and addition instructions in the manner described below may produce useful results for applications having less stringent accuracy and precision requirements.

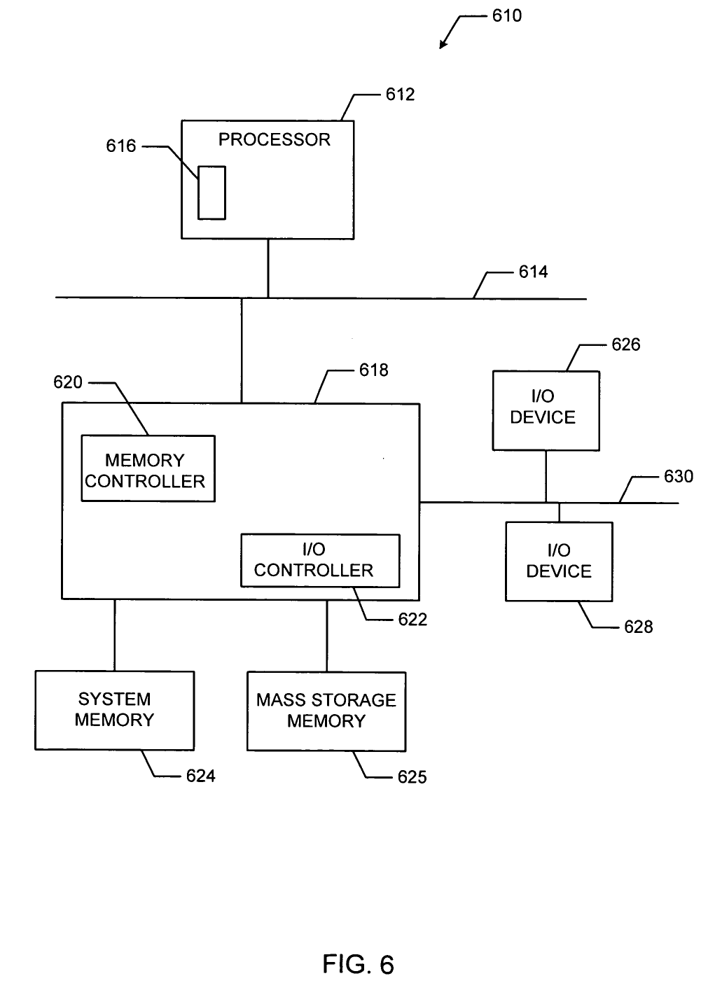

The example method may be arranged in two phases including a design phase 202 and a runtime phase 204. The design phase 202 may occur prior to the runtime phase 204 and is associated with the time at which software or firmware code (e.g., machine accessible and executable code or instructions) is developed (e.g., written, generated, etc.). The software or firmware code may be developed by a programmer or a software developer, which may be a person or an application executed on, for example, the processor system 610 (FIG. 6). The machine accessible or readable code or instructions may be written in any programming language such as, for example, C/C++, Basic, Java, assembler, etc. In addition, the design phase 202 may include a compilation process that stores instructions and predetermined values in memory for use during the runtime phase 204. In particular, the operations of the design phase 202 may be used to generate, determine, and/or identify predetermined values that may be generated once, stored in a memory during the compilation process, and retrieved multiple times during the runtime phase 204 for use in, for example, determining quotient and remainder values as described in greater detail below.

The runtime phase 204 typically occurs any time after the design phase 202 and is associated with a time at which operations for generating, determining, or otherwise identifying a quotient value may be performed. In particular, the instructions and predetermined values stored in memory during the design phase 202 may be used to determine quotient and remainder values as described below.

Although, the design phase 202 and the runtime phase 204 are shown as being separate in FIG. 2, at least one or more operations of the design phase 202 may be performed during the runtime phase 204. For example, predetermined values typically determined during the design phase 202 may alternatively be determined during the runtime phase 204.

Now turning in detail to FIG. 2, initially, a reciprocal value 1/m of a divisor value m is identified (e.g., generated, determined, etc.) (block 206). The divisor value m may be an integer value and may be known prior to the runtime phase 204. The reciprocal value 1/m may be determined by performing an inverse operation on the divisor value m. The reciprocal value 1/m may be stored in floating-point format to maintain precision.

A bias value S₀ is then determined (block 208) based on the floating-point data type format of the registers that are used to store the values (e.g., the reciprocal value 1/m, a dividend value n, etc.) during the runtime phase 204. More specifically, the bias value S₀ is selected based on the precision of the floating-point data type to select a truncation bias value S as described below. For example, if the operations of the runtime phase 204 are executed on a processor supporting the double precision floating-point data type described above in connection with FIG. 1, the bias value S₀ is set equal to 2⁵². In this case, the bias value S₀ is set equal to two to the power of the bit length (i.e., fifty-two) of the mantissa bitfield 106 (FIG. 1) for the double precision floating-point data type.

A truncation bias value S is then determined (block 210) based on the bias value S₀. The truncation bias value S is used to fix the binary points of the values determined during the runtime phase 204 to force an integer truncation. By way of example, an integer truncation causes a value of 3.9 to be truncated to a value of three. More specifically, the truncation bias value S is set equal to at least a portion of the bias value S₀ by subtracting one-half from the bias value S₀ (i.e., S=S₀−0.5). To subtract the value one-half from the bias value S₀, the values are first represented in floating-point format and the value one-half is denormalized. Denormalization is well known in the art and may be used to set the fp-exponent value (described above in connection with FIG. 1) of the bias value S₀, which is written in floating-point notation equal to the fp-exponent value of the value one-half, which is written in floating-point notation.

After the exponent values are made equal, the value one-half may be subtracted from the bias value S₀. Subtracting one-half from the bias value S₀ causes the truncation bias value S to have a floating-point exponent value equal to the exponent value of the bias value S₀ minus one (e.g., 51=52−1). Additionally, the bits of the mantissa bitfield 106 (FIG. 1) are set equal to one. As is well known in the art, the floating-point representation of the truncation bias value S may be written in scientific notation as 2⁵¹·(1.111 . . . 111) according to Equation 1 above. When the truncation bias value S is used in an accumulate or addition operation as described below, an integer representation of a quotient value is shifted to the right-most bits of the mantissa bitfield 106 to perform an integer truncation operation.

After determining the reciprocal value 1/m, the bias value S₀, and the truncation bias value S, the values are stored for subsequent use (block 212). For example, the values (i.e., 1/m, S₀, and S) may be stored in a memory (e.g. at least one of the system memory 624 and the mass storage memory 625 of FIG. 6) for use during the runtime phase 204. Alternatively, if the operations associated with blocks 206, 208, and 210 are performed during the runtime phase 204, the values (i.e., 1/m, S₀, and S) may be stored in floating-point registers (e.g., the floating-point registers in the register space 616 of FIG. 6) for subsequent use by the operations indicated in FIG. 2 as being part of the runtime phase 204.

It is then determined if the quotient value is to be determined using a fused multiply accumulate instruction (block 214). If the quotient value is determined using an FMA instruction, an FMA instruction is executed (block 216) to determine a biased quotient value Q according to Equation 3 below.

$$Q = S + n \cdot \frac{1}{m} \qquad Equation 3$$

As shown in Equation 3 above, the multiplication operation of the FMA instruction determines a product by multiplying a dividend value n by the value of the reciprocal value 1/m to infinite precision. The dividend value n may be any integer value and may be provided during the runtime phase 204. The addition operation of the FMA instruction then adds the truncation bias value S to the product of the multiplication operation (e.g.,

$$n \cdot \frac{1}{m}$$

) to produce a value having infinite precision that is then rounded according to the precision parameter pc of the FMA instruction described above to generate the biased quotient value Q.

The biased quotient value Q includes the quotient value q in the right-most bits of the mantissa bitfield 106 (FIG. 1). In particular, the product of the multiplication operation

$$n \cdot \frac{1}{m}$$

is equal to a non-integer intermediate quotient value q′. More specifically, adding the truncation bias value S to the product of the multiplication operation

$$n \cdot \frac{1}{m}$$

shifts the intermediate quotient value q′ to the right-most bits of the mantissa bitfield 106. In this manner, an integer truncation is performed on the intermediate quotient value q′ to generate the quotient value q in integer form in the right-most bits of the mantissa bitfield 106. Recovering the quotient value q from the biased quotient value Q is described in detail below.

An alternate method for determining the biased quotient value Q is based on separate multiplication and addition operations. If it is determined at block 214 that the FMA instruction is not used to determine the quotient value q, the non-integer intermediate quotient value q′ is first determined using a multiplication operation (block 218). In particular, the intermediate quotient value q′ is determined by multiplying the dividend value n by the reciprocal value 1/m using a floating-point multiplication instruction. The biased quotient value Q is then determined by adding the intermediate quotient value q′ to the truncation bias value S using a floating-point addition instruction (block 220). As described above, the addition operation performs an integer truncation on the intermediate quotient value q′ and causes the integer quotient value q to be placed in the right-most bits of the biased quotient value Q.

After the biased quotient value Q is determined at block 216 or block 220, the quotient value q is determined (block 222). In one example, the quotient value q may be recovered using a subtraction operation based on the bias value S₀. More specifically, the bias value S₀ may be subtracted from the biased quotient value Q using a floating-point subtraction instruction to determine the quotient value q. In another example, the quotient value q may be recovered using a bitfield extraction operation. In particular, the quotient value q may be extracted from the mantissa bitfield 106 (FIG. 1) by extracting all of the bits of the mantissa bitfield 106 or by locating the left-most bit having a value of one and extracting the bits between and including the right-most bit and the left-most bit having a value of one.

It is then determined if a remainder value r is to be determined (block 224). If the remainder value r is to be determined, a fused negative multiply accumulate (FNMA) instruction (i.e., a floating-point negative multiply add instruction) may be executed (block 226) based on the quotient value q, the divisor value m, and the dividend value n. The FNMA instruction, which is written in the Intel® IA-64 Architecture instruction set as fnma.pc.sf f₁,=f₃,f₄,f₂ may be represented mathematically according to Equation 4 below.
f₁=−(f₃×f₄)+f₂ Equation 4
As set forth in Equation 4 above, the remainder value r corresponds to the value f₁, the dividend value n corresponds to the value f₂, the quotient value q corresponds to the value f₃, and the divisor value m corresponds to the value f₄. In particular, the FNMA instruction first determines the product of the values f₃ and f₄ to infinite precision. The product is then negated and the value f₂ is added to the negated product, again producing a result having infinite precision. The resulting value of the addition operation is then rounded to a desired precision and stored as the value f₁ (i.e., the remainder value r). In the Intel® IA-64 Architecture, the desired precision is indicated by the parameter pc of the FNMA instruction and may be set to single precision or double precision. Other instructions or combinations thereof may also be used to recover the remainder value r from the quotient value q such as, for example, a fused multiply subtract (FMS) instruction (i.e., a floating-point multiply subtract instruction), discrete multiplication, negation, addition, and/or subtraction instructions, etc.

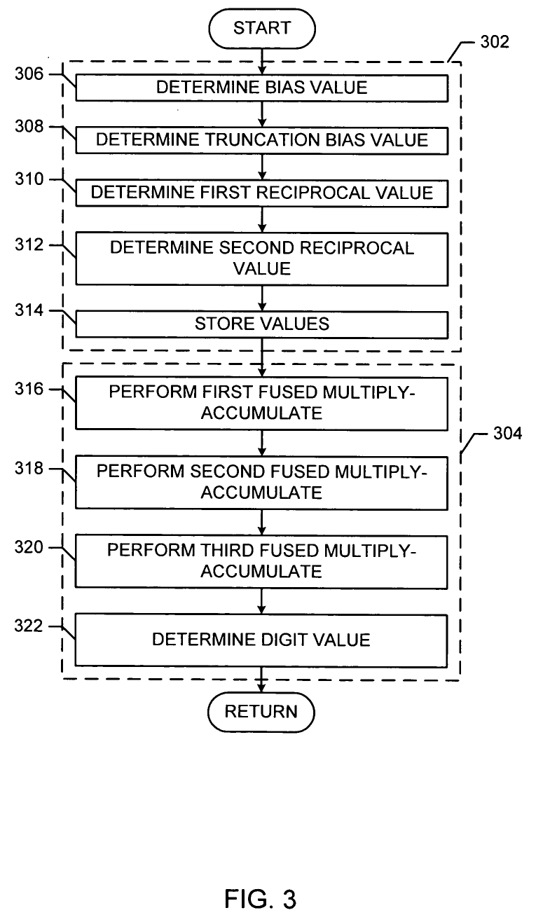

FIG. 3 is a flow diagram of a base conversion application that may be implemented using the fused multiply accumulate instruction and the example methods of FIG. 2. Processor systems (e.g., the processor system 610 of FIG. 6) store values in binary (i.e., base-two) format. It is often necessary to convert the stored binary values to different base values. For example, many applications require numerical values to be displayed in decimal or base-ten format to enable users (e.g., people) to read, interact with, and/or modify the values. This need typically results in performance of a base conversion operation every time a numerical value is displayed to a user. Optimizing the process used to perform base conversions is essential to reducing processing overhead.

The example method of FIG. 3 may be partitioned into two phases including a design phase 302 and a runtime phase 304. Although the flow diagram of FIG. 3 shows certain operations in the design phase 302 and certain operations in the runtime phase 304, at least one or more of the operations described in connection with FIG. 3 as being part of the design phase 302 may alternatively be performed during the runtime phase 204.

Initially, a bias value S₀ is determined (block 306). The function of the bias value S₀ is identical to the function of the bias value S₀ described above in connection with FIG. 2. Additionally, the bias value S₀ may be selected based on the precision of the floating-point registers that are used to perform the floating-point operations (e.g., the FMA instruction) described below. For example, if the floating-point registers are double precision, the bias value S₀ may be set equal to 2⁵².

A truncation bias value S is then determined based on the bias value S₀(block 308). The function of the truncation bias value S is identical to the function of the truncation bias value S described above in connection with FIG. 2 and may be determined in a similar manner. More specifically, the truncation bias value S is set equal to the result of subtracting a value of one-half from the bias value S₀ (i.e., S=S₀−0.5).

A first reciprocal value uᵢ may then be determined (block 310). The reciprocal value uᵢ is determined based on a base value B (i.e., the base to which values are to be converted). For example, if the desired base representation is decimal or base-ten, the base value B is set equal to ten. In particular, the reciprocal value uᵢ is determined by performing an inverse operation on the base value B raised to the power of a digit index value i (i.e., 1/Bⁱ).

The digit index value i corresponds to a particular digit of a value that is being converted. For example, if the numerical value 524 is being converted from a binary format to a decimal format, the digit index values i of the hundreds position (i.e., 5), the tens position (i.e., 2), and the ones position (i.e., 4) are equal to respective values two, one, and zero. Therefore, if the hundreds position value is to be converted, the first reciprocal value uᵢ is set equal to the inverse value of B² (i.e.,

$${u}_{i = 2} = \frac{1}{{B}^{2}}$$

).

A second reciprocal value uᵢ₊₁ may also be determined based on the base value B (block 312). In particular, the second reciprocal value uᵢ₊₁ may be determined by performing an inverse operation on the base value B raised to the power of the digit index value added to one (i.e.,

$${u}_{i + 1} = \frac{1}{{B}^{i + 1}}$$

).

The values (i.e., the bias value S₀, the truncation bias value S, the first reciprocal value uᵢ, and the second reciprocal value uᵢ₊₁) determined in connection with blocks 306, 308, 310, and 312 may then be stored for subsequent use (block 314). For example, if the values are determined during the design phase 302, they may be stored in a memory location for subsequent retrieval during the runtime phase 304. Alternatively, if the values are determined during the runtime phase 304, they may be stored in a memory (e.g., one or both of the system memory 624 and mass storage memory 625 of FIG. 6) and/or floating-point registers (e.g., the floating-point registers in the register space 616 of FIG. 6) for immediate use.

A first FMA operation is performed to determine a first biased quotient value Qᵢ (block 316). More specifically, the first FMA operation is performed according to Equation 5 below.
Qᵢ=(n×uᵢ)+S Equation 5
As shown in Equation 5, the first FMA operation is performed based on a dividend value n, the first reciprocal value uᵢ, and the truncation bias value S. The dividend value n is the numerical value that is to be converted to a different base format (e.g., decimal or base-ten format). For example, the dividend value n may be an integer binary value that is retrieved from memory, stored in a floating-point register, and displayed on, for example, a monitor in base-ten format. The first FMA operation determines a product by multiplying the dividend value n by the first reciprocal value uᵢ to infinite precision. The truncation bias value S is then added to the product to produce a result having infinite precision. The result is then rounded according to the precision parameter pc of the FMA instruction described above to generate the first biased quotient value Qᵢ.

A second FMA operation is then performed to determine a second biased quotient value Qᵢ₊₁ (block 318). The second FMA operation is performed according to Equation 6 below.
Qᵢ₊₁=(n×uᵢ₊₁)+S Equation 6
As shown in Equation 6, the second FMA operation is performed based on the dividend value n, the second reciprocal value uᵢ₊₁, and the truncation bias value S. The second FMA operation determines a product by multiplying the dividend value n by the second reciprocal value uᵢ₊₁ to infinite precision. The truncation bias value S is then added to the product to produce a result having infinite precision. The result is then rounded to generate the second biased quotient value Qᵢ₊₁.

After the first biased quotient value Qᵢ and the second biased quotient value Qᵢ₊₁ are determined, a third FMA operation is performed to determine a biased digit value Dᵢ (block 320). The biased digit value Dᵢ includes the value of a digit value d indexed by the digit index value i (i.e., dᵢ). For example, for the numerical value 524, if the index value i is equal to 2, the digit dᵢ corresponds to the value in the hundreds position (i.e., 5). The third FMA operation is performed according to Equation 7 below.
Dᵢ=(−B×Qᵢ₊₁)+Qᵢ Equation 7
As shown in Equation 7, the third FMA operation is performed based on the base value B, the first biased quotient value Qᵢ, and the second biased quotient value Qᵢ₊₁. Prior to performing the third FMA instruction, the base value B may be negated using, for example, a negate operation. The third FMA operation determines a product by multiplying the negated base value −B by the second biased quotient value Qᵢ₊₁. The first biased value Qᵢ is then added to the product to generate a result that is rounded according to the precision parameter pc of the FMA instruction described above. The rounded value is stored as the biased digit value Dᵢ. In an alternate implementation, the biased digit value Dᵢ may be determined using the fused negative multiply accumulate (FNMA) instruction described above in connection with FIG. 2 or any other suitable instruction (e.g., the fused multiply subtract instruction (FMS)). In this manner, the base value B does not need to be negated using a separate instruction.

The digit value dᵢ may then be determined based the biased digit value Dᵢ(block 322). In particular, the digit value dᵢ is determined according to Equation 8 below.
dᵢ=Dᵢ+S₀·(B−1) Equation 8
As shown in Equation 8 above, the digit value dᵢ may be determined by first subtracting one from the base value B. The result of the subtraction is then multiplied by the bias value S₀ to produce a product S₀·(B−1). The product is then added to the biased digit value Dᵢ to determine the digit value dᵢ. The calculation of Equation 8 may be performed using any suitable instruction or instructions such as, for example, the FMA instruction, the FNMA instruction, the FMS instruction, and/or any combination of separate multiplication, addition, negation, and/or subtraction instructions.

In another example, the biased digit value Dᵢ is biased by the bias value S₀, which enables the digit value dᵢ to be extracted from a bitfield comprising the biased digit value Dᵢ. More specifically, the bias value S₀ is determined based on the precision of a floating-point data type format and typically results in a bias value S₀ having a relatively large magnitude (e.g., 2⁵²). In general, the relatively large magnitude of the bias value S₀ affects the left-most bits of the biased digit value Dᵢ. Using the truncation bias value S as shown in Equations 5 and 6 to determine the first and second biased quotient values Qᵢ and Qᵢ₊₁ causes the digit value dᵢ to be shifted to the right-most bits of the biased digit value Dᵢ. Thus, the bias value S₀ does not affect (i.e., change, modify, etc.) the digit value dᵢ, which can be extracted from the right-most bits of the bitfield comprising the biased digit value Dᵢ. More specifically, the digit value dᵢ may be determined by extracting the bits of the mantissa bitfield 106 (FIG. 1) of a floating-point register in which the biased digit value Dᵢ is stored. Alternatively, the digit value dᵢ may be extracted by searching for the left-most bit value of one in the mantissa bitfield 106 and extracting the bits between and including the left-most bit value of one and the right-most bit of the mantissa bitfield 106.

Although, the example method of FIG. 3 is described as determining one digit value dᵢ, the example method may be used to determine any number of digit values dᵢ corresponding to a numerical value by changing the digit index value i and repeating the operations described in connection with the example method.

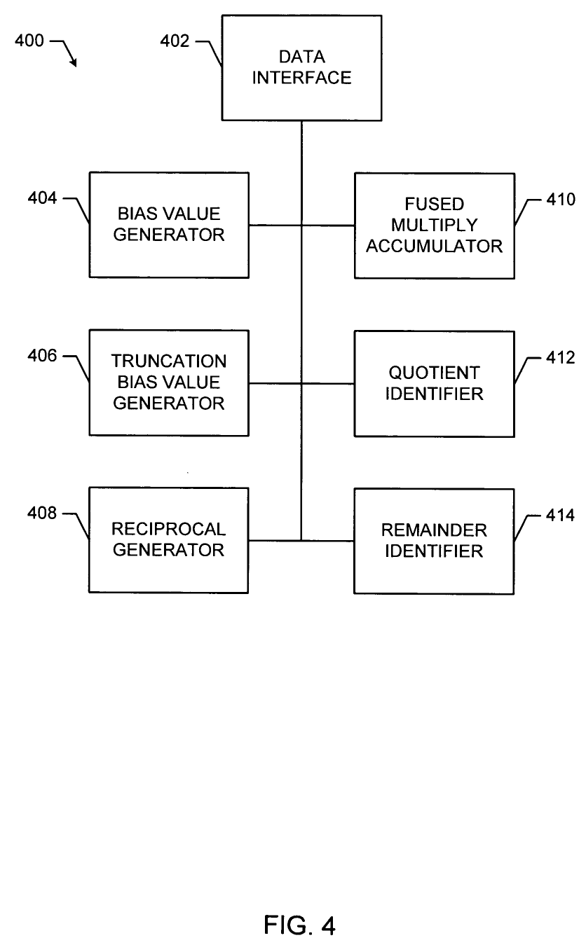

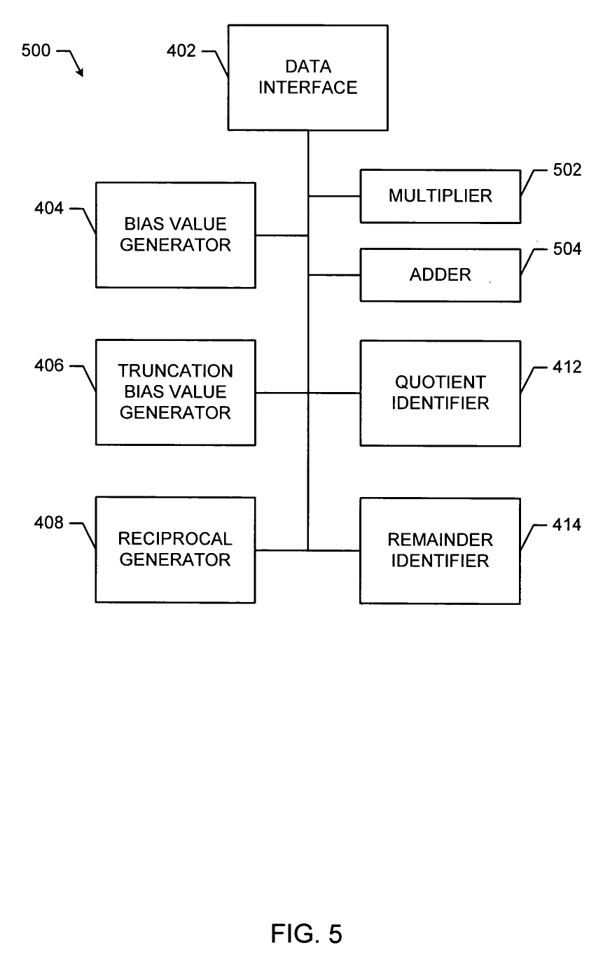

The example methods described above in connection with FIGS. 2 and 3 may be implemented in hardware, software, and/or any combination thereof. For example, the example methods may be implemented in a hardware system such as, for example, one or both of the example systems 400 and 500 described below in connection with FIGS. 4 and 5. Additionally or alternatively, the example methods may be implemented in software that is stored on a machine accessible medium and executed by a processor system such as, for example, the processor system 610 of FIG. 6.

FIG. 4 is a block diagram of an example system 400 that may be configured to determine a quotient value and a remainder value. In particular, the example system 400 is configured to determine quotient and remainder values using a fused multiply accumulate operation as described above in connection with the example method of FIG. 2. As shown in FIG. 2, the example system 400 includes a data interface 402, a bias value generator 404, a truncation bias value generator 406, a reciprocal generator 408, a fused multiply accumulator 410, a quotient identifier 412, and a remainder identifier 414, all of which may be communicatively coupled as shown.

The data interface 402 may be communicatively coupled to any memory (e.g., one or both of the system memory 624 and the mass storage memory 625 of FIG. 6), registers (e.g., the register space 616 of FIG. 6), and/or any data storage device. In particular, the data interface 402 may be configured to retrieve and/or store values associated with determining quotient and remainder values as described herein such as, for example, a dividend value n, a divisor value m, a reciprocal value 1/m, a bias value S₀, a truncation bias value S, etc. Each of the blocks of the example system 400 is communicatively coupled to the data interface 402 and may be configured to read from and/or write to the data interface 402. In this manner, results generated by the blocks of the example system 400 may be stored in memory and/or register locations via the data interface 402 for subsequent use by other blocks. Alternatively, each of the blocks of the example system 400 may be configured to communicate their results directly to other blocks.

The bias value generator 404 is configured to generate the bias value S₀ described above in connection with FIG. 2. More specifically, the bias value generator 404 may retrieve a value from the data interface 402 that indicates the precision of floating-point registers (i.e., the floating-point registers in the register space 616 of FIG. 6) to be used in determining the quotient and remainder values. For example, the data interface 402 may retrieve a precision variable from memory used to store the precision value of a floating-point data type and communicate the precision value to the bias value generator 404. The bias value generator 404 may then raise two to the power of the precision value (e.g., 2⁵²) to generate the bias value S₀.

The truncation bias value generator 406 is configured to generate the truncation bias value S described above in connection with FIG. 2. More specifically, the truncation bias value generator 406 may retrieve the bias value S₀ from the bias value generator 404 or from the data interface 402 and generate the truncation bias value S by subtracting the value one-half from the bias value S₀ (i.e., S=S₀−0.5).

The reciprocal generator 408 may be configured to generate the reciprocal value 1/m described above in connection with FIG. 2. The reciprocal generator 408 may be configured to retrieve a divisor value m from the data interface 402 and generate the reciprocal value 1/m by inverting the divisor value m.

The fused multiply accumulator 410 is configured to perform fused multiply accumulate operations to generate the biased quotient value Q as described above in connection with block 216 of FIG. 2. In particular, the fused multiply accumulator 410 may be configured to retrieve the dividend value n from the data interface 402, the reciprocal value 1/m from the reciprocal generator 408 or the data interface 402, and the truncation bias value S from the truncation bias value generator 406 or the data interface 402. The fused multiply accumulator 410 may then perform a fused multiply accumulate operation based on the retrieved values as described above in connection with block 216 of FIG. 2 to generate the biased quotient value Q.

The quotient identifier 412 is configured to identify or determine a quotient value q based on the biased quotient value Q as described above in connection with block 222 of FIG. 2. More specifically, the quotient identifier 412 may be configured to retrieve the bias value S₀ from the bias value generator 404 or from the data interface 402. The quotient identifier 412 may then determine the quotient value q by subtracting the bias value S₀ from the biased quotient value Q. Alternatively, the quotient value identifier 412 may identify or determine the quotient value q by extracting the mantissa bitfield 106 (FIG. 1) of the biased quotient value Q.

The remainder identifier 414 may be configured to identify or determine the remainder value r based on the quotient value q, the dividend value n, and the divisor value m as described above in connection with block 226 of FIG. 2. In particular, the remainder identifier 414 may be configured to retrieve the dividend value n and the divisor value m from the data interface 402 and the quotient value q from the quotient identifier 412 or the data interface 402. The remainder identifier 414 may then perform a calculation according to Equation 3 above, where the remainder value r corresponds to the value f₁, the dividend value n corresponds to the value f₂, the quotient value q corresponds to the value f₃, and the divisor value m corresponds to the value f₄. Any suitable operation or combination of operations may be performed by the remainder identifier 414 to determine the remainder value r such as, for example, a fused negative multiply accumulate operation, a fused multiply subtract operation, a negation operation in combination with a fused multiply accumulate operation, etc.

FIG. 5 is a block diagram of another example system 500 that may be configured to determine a quotient value and a remainder value. More specifically, the example system 500 may be used to determine quotient and remainder values based on separate multiplication and addition operations as described above in connection with the example method of FIG. 2. As shown in FIG. 5, the example system 500 includes the data interface 402, the bias value generator 404, the truncation bias value generator 406, the reciprocal generator 408, the quotient identifier 412, and the remainder identifier 414 of the example system 400 (FIG. 4), all of which are communicatively coupled as shown. As implemented in the example system 500, the blocks 402, 404, 406, 408, 412, and 414 function in a substantially similar or identical manner as the like-numbered blocks in the example system 400. In addition, the example system 500 includes a multiplier 502 and an adder 504, which are communicatively coupled as shown.

The multiplier 502 is configured to determine the intermediate quotient value q′ described above in connection with FIG. 2. In particular, the multiplier 502 may be configured to retrieve the dividend value n from the data interface 402 and the reciprocal value 1/m from the reciprocal generator 408 or the data interface 402. The multiplier 502 may then determine the intermediate quotient value q′ by performing a floating-point multiplication operation based on the dividend value n and the reciprocal value 1/m.

The adder 504 is configured to determine the biased quotient value Q described above in connection with FIG. 2. More specifically, the adder 504 may be configured to retrieve the truncation bias value S from the truncation bias value generator 406 and the intermediate quotient value q′ from the multiplier 504. Alternatively, both values S and q′ may be retrieved from the data interface 402. The adder 504 may then perform a floating-point addition operation based on the truncation bias value S and the intermediate quotient value q′ to determine the biased quotient value Q.

The example systems 400 and 500 described above may be divided in two portions including a design phase (e.g., the design phase 202 of FIG. 2) and a runtime phase (e.g., the runtime phase 204 of FIG. 2) in which a portion of the blocks perform operations during the design phase and another portion of the blocks perform operations during the runtime phase. For example, blocks that are configured to generate pre-determined values (e.g., the bias value S₀, the truncation bias value S, the reciprocal value 1/m) may be performed during the design phase and all other blocks may be performed during the runtime phase. Alternatively, the operation associated with all of the blocks may be performed during the runtime phase.

FIG. 6 is a block diagram of an example processor system 610 that may be used to implement the apparatus and methods described herein. As shown in FIG. 6, the processor system 610 includes a processor 612 that is coupled to an interconnection bus or network 614. The processor 612 includes a register set or register space 616, which is depicted in FIG. 6 as being entirely on-chip, but which could alternatively be located entirely or partially off-chip and directly coupled to the processor 612 via dedicated electrical connections and/or via the interconnection network or bus 614.

The processor 612 may be any suitable processor, processing unit or microprocessor such as, for example, a processor from the Intel X-Scale™ family, the Intel Pentium™ family, etc. In the example described in detail below, the processor 612 is a thirty-two bit Intel processor, which is commonly referred to as an IA-32 processor. Although not shown in FIG. 6, the system 610 may be a multi-processor system and, thus, may include one or more additional processors that are identical or similar to the processor 612 and which are coupled to the interconnection bus or network 614.

The register space 616 may include floating-point registers and/or integer registers. The floating-point registers may be configured to store floating-point values represented in, for example, single precision format, double precision format, and/or any other floating-point format suitable for any particular application.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 via an I/O bus 630. The I/O devices 626 and 628 may be any desired type of I/O device such as, for example, a keyboard, a video display or monitor, a mouse, etc. While the memory controller 620 and the I/O controller 622 are depicted in FIG. 6 as separate functional blocks within the chipset 618, the functions performed by these blocks may be integrated within a single semiconductor circuit or may be implemented using two or more separate integrated circuits.

The methods described herein may be implemented using instructions stored on a computer readable medium that are executed by the processor 612. The computer readable medium (machine accessible medium) may include any desired combination of solid state, magnetic and/or optical media implemented using any desired combination of mass storage devices (e.g., disk drive), removable storage devices (e.g., floppy disks, memory cards or sticks, etc.) and/or integrated memory devices (e.g., random access memory, flash memory, etc.).

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method comprising:
identifying a reciprocal value of a divisor value;
identifying a bias value;
executing a first machine accessible instruction to determine a biased quotient value based on a dividend value, the reciprocal value, and at least a portion of the bias value; and
executing a second machine accessible instruction to determine a quotient value based on the biased quotient value.

2. A method as defined in claim 1, wherein executing the first machine accessible instruction to determine the biased quotient value comprises:
determining an intermediate quotient value based on the dividend value and the reciprocal value using a multiplication operation; and
determining the biased quotient value based on the intermediate quotient value and at least a portion of the bias value using an addition operation.

3. A method as defined in claim 1, wherein executing the first machine accessible instruction to determine the biased quotient value includes using a fused multiply accumulate instruction.

4. A method as defined in claim 1, further comprising determining a remainder value based on the quotient value using at least one of a fused multiply accumulate instruction, a fused negate multiply accumulate instruction, and a fused multiply subtract instruction.

5. A method as defined in claim 1, wherein the bias value is associated with a floating-point data type format.

6. A method as defined in claim 1, wherein executing the second machine accessible instruction to determine the quotient value includes subtracting the bias value from the biased quotient value.

7. A method as defined in claim 1, wherein executing the second machine accessible instruction to determine the quotient value includes extracting the quotient value from a bitfield associated with the biased quotient value.

8. A method as defined in claim 1, wherein the at least a portion of the bias value is determined by subtracting a value from the bias value.

9. An apparatus comprising:
a processor system including a memory; and
instructions stored in the memory that enable the processor system to:
identify a reciprocal value of a divisor value;
identify a bias value;
determine a biased quotient value based on a dividend value, the reciprocal value, and at least a portion of the bias value; and
determine a quotient value based on the biased quotient value.

10. An apparatus as defined in claim 9, wherein the instructions stored in the memory enable the processor system to determine the biased quotient value by:
determining an intermediate quotient value based on the dividend value and the reciprocal value using a multiplication operation; and
determining the biased quotient value based on the intermediate quotient value and at least a portion of the bias value using an addition operation.

11. An apparatus as defined in claim 9, wherein the instructions stored in the memory enable the processor system to determine the biased quotient value using a fused multiply accumulate instruction.

12. An apparatus as defined in claim 9, wherein the instructions stored in the memory enable the processor system to determine a remainder value based on the quotient value using at least one of a fused multiply accumulate instruction, a fused negate multiply accumulate instruction, and a fused multiply subtract instruction.

13. An apparatus as defined in claim 9, wherein the bias value is associated with a floating-point data type format.

14. An apparatus as defined in claim 9, wherein the instructions stored in the memory enable the processor system to determine the quotient value by subtracting the bias value from the biased quotient value.

15. An apparatus as defined in claim 9, wherein the instructions stored in the memory enable the processor system to determine the quotient value by extracting the quotient value from a bitfield associated with the biased quotient value.

16. A machine accessible medium having instructions stored thereon that, when executed, cause a machine to:
identify a reciprocal value of a divisor value;
identify a bias value;
determine a biased quotient value based on a dividend value, the reciprocal value, and at least a portion of the bias value; and
determine a quotient value based on the biased quotient value.

17. A machine accessible medium as defined in claim 16 having instructions stored thereon that, when executed, cause the machine to determine the biased quotient value by:
determining an intermediate quotient value based on the dividend value and the reciprocal value using a multiplication operation; and
determining the biased quotient value based on the intermediate quotient value and at least a portion of the bias value using an addition operation.

18. A machine accessible medium as defined in claim 16 having instructions stored thereon that, when executed, cause the machine to determine the biased quotient value using a fused multiply accumulate instruction.

19. A machine accessible medium as defined in claim 16 having instructions stored thereon that, when executed, cause the machine to determine a remainder value based on the quotient value using at least one of a fused multiply accumulate instruction, a fused negate multiply accumulate instruction, and a fused multiply subtract instruction.

20. A machine accessible medium as defined in claim 16, wherein the bias value is associated with a floating-point data type format.

21. A machine accessible medium as defined in claim 16 having instructions stored thereon that, when executed, cause the machine to determine the quotient value by subtracting the bias value from the biased quotient value.

22. A machine accessible medium as defined in claim 16 having instructions stored thereon that, when executed, cause the machine to determine the quotient value by extracting the quotient value from a bitfield associated with the biased quotient value.

23. A system comprising:
a fused multiply accumulator configured to generate a biased quotient value based on a reciprocal value of a divisor value, a dividend value, and at least a portion of a bias value; and
a quotient value identifier configured to identify a quotient value based on the biased quotient value and the bias value.

24. A system as defined in claim 23, wherein the bias value is associated with a floating-point data type format.

25. A system as defined in claim 23, wherein the quotient value identifier is configured to identify the quotient value by subtracting the bias value from the biased quotient value.

26. A system as defined in claim 23, wherein the quotient value identifier is configured to identify the quotient value by extracting the quotient value from a bitfield associated with the biased quotient value.

27. A system comprising:
a multiplier configured to generate an intermediate quotient value based on a reciprocal value of a divisor value and a dividend value;
an adder configured to generate a biased quotient value based on the intermediate quotient value and at least a portion of a bias value; and
a quotient value identifier configured to identify a quotient value based on the biased quotient value and the bias value.

28. A system as defined in claim 27, wherein the bias value is associated with a floating-point data type format.

29. A system as defined in claim 27, wherein the quotient value identifier is configured to identify the quotient value by subtracting the bias value from the biased quotient value.

30. A system as defined in claim 27, wherein the quotient value identifier is configured to identify the quotient value by extracting the quotient value from a bitfield associated with the biased quotient value.
